(19) United States
(12) Patent Application Publication
(10) Pub. No.: US 2025/0088923 A1
(43) Pub. Date: Mar. 13, 2025

(54) CELL CONFIGURATION METHOD, TERMINAL, AND BASE STATION

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN); Jiangsheng FAN, Dongguan (CN)

(21) Appl. No.: 18/961,647

(22) Filed: Nov. 27, 2024

Related U.S. Application Data
(63) Continuation of application No. PCT/CN2022/096665, filed on Jun. 1, 2022.

(51) Int. Cl. H04W 36/04; H04W 16/32

(52) U.S. Cl. CPC H04W 36/04; H04W 16/32

(57) ABSTRACT

Provided is a cell configuration method, including: receiving candidate configuration information from a base station, wherein the candidate configuration information includes a candidate cell configuration; receiving first indication information from the base station over L1 signaling or L2 signaling, wherein the first indication information indicates that a primary cell and/or a secondary cell of the terminal is changed; and configuring the primary cell and/or the secondary cell of the terminal based on the first indication information and the candidate configuration information.

### CROSS-REFERENCE TO RELATED APPLICATION

This application is a continuation application of international application No. PCT/CN2022/096665, filed on Jun. 1, 2022, the disclosure of which is herein incorporated by reference in its entirety.

### TECHNICAL FIELD

The present disclosure relates to the technical field of wireless communications, and in particular, to a cell configuration method, a terminal, a base station, a storage medium and a program product.

### RELATED ART

In a wireless communication scenario, carrier aggregation (CA) is used between a base station and a terminal to increase the available bandwidth, thereby increasing the transmission rate.

In a CA scenario, when the terminal performs cell handover, a primary cell and a secondary cell generally need to be changed. In the related art, the base station needs to send configuration information of the secondary cell upon handover to the terminal in advance over radio resource control (RRC) signaling.

### SUMMARY

Embodiments of the present disclosure provide a cell configuration method, a terminal, and a base station. The technical solutions are as follows.

Some embodiments of the present disclosure provide a cell configuration method, applicable to a terminal, the method including:

receiving candidate configuration information from a base station, wherein the candidate configuration information includes a candidate cell configuration;

receiving first indication information from the base station over L1 signaling or L2 signaling, wherein the first indication information indicates that a primary cell and/or a secondary cell of the terminal is changed; and

configuring the primary cell and/or the secondary cell of the terminal based on the first indication information and the candidate configuration information.

Some embodiments of the present disclosure provide a cell configuration method, applicable to a base station, the method including:

sending candidate configuration information to a terminal, wherein the candidate configuration information includes a candidate cell configuration; and

sending first indication information to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

Some embodiments of the present disclosure provide a terminal, including a processor, a memory, and a transceiver, wherein

the transceiver is configured to receive candidate configuration information from a base station, wherein the candidate configuration information includes a candidate cell configuration; and receive first indication information from the base station over L1 signaling or L2 signaling, and the first indication information indicates that a primary cell and/or a secondary cell of the terminal is changed; and

the processor is configured to configure the primary cell and/or the secondary cell of the terminal based on the first indication information and the candidate configuration information.

Some embodiments of the present disclosure provide a base station, including a processor, a memory, and a transceiver, wherein

the transceiver is configured to send candidate configuration information to a terminal, wherein the candidate configuration information includes a candidate cell configuration; and send first indication information to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

### BRIEF DESCRIPTION OF DRAWINGS

For clearer descriptions of the technical solutions in the embodiments of the present disclosure, the accompanying drawings required for describing the embodiments are briefly introduced below. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of a network architecture of a communication system according to some embodiments of the present disclosure;

FIG. 2 is a schematic diagram of a secondary cell activation/deactivation message according to the present disclosure;

FIG. 3 is a schematic flowchart of cell handover across base stations according to the present disclosure;

FIG. 4 is a flowchart of a cell configuration method according to some embodiments of the present disclosure;

FIG. 5 is a flowchart of a cell configuration method according to some embodiments of the present disclosure;

FIG. 6 is a schematic diagram of a cell configuration process according to some embodiments of the present disclosure;

FIG. 7 is a flowchart of a cell configuration method according to some embodiments of the present disclosure;

FIG. 8 is a flowchart of a cell configuration method according to some embodiments of the present disclosure;

FIG. 9 is a schematic diagram of association in the embodiments shown in FIG. 8;

FIG. 10 is a schematic diagram of association in the embodiments shown in FIG. 8;

FIG. 11 is a block diagram of a cell configuration apparatus according to some embodiments of the present disclosure;

FIG. 12 is a block diagram of a cell configuration apparatus according to some embodiments of the present disclosure; and

FIG. 13 is a schematic structural diagram of a computer device according to some embodiments of the present disclosure.

### DETAILED DESCRIPTION

For clearer descriptions of the objects, technical solutions, and advantages of the present disclosure, the embodiments of the present disclosure are further described in detail below with reference to the accompanying drawings.

A network architecture and a service scenario described in the embodiments of the present disclosure are intended to describe the technical solutions in the embodiments of the present disclosure more clearly, but do not constitute any limitation on the technical solutions according to the embodiments of the present disclosure. Those of ordinary skill in the art are clear that, with the evolution of the network architecture and the emergence of a new service scenario, the technical solutions according to the embodiments of the present disclosure are also applicable to similar technical problems.

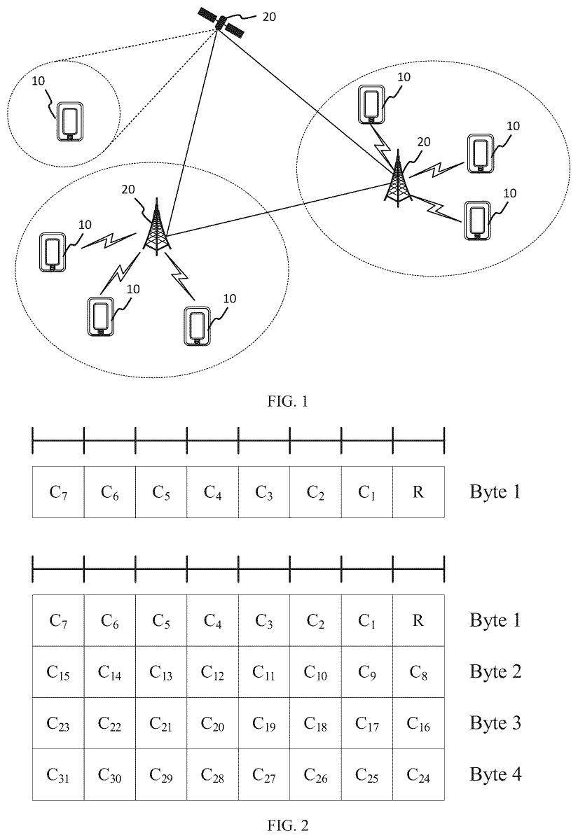

FIG. 1 is a schematic diagram of a network architecture of a communication system according to some embodiments of the present disclosure. The network architecture includes a terminal 10 and a base station 20.

A plurality of terminals 10 are generally provided. One or more terminals 10 are distributed in a cell managed by each base station 20. The terminal 10 includes various handheld devices, vehicle-mounted devices, wearable devices, and computing devices that have a wireless communication function, or other processing devices connected to a wireless modem, and various forms of user equipments (UEs), mobile stations (MSs), terminal devices, and the like. For ease of description, in the embodiments of the present disclosure, the devices mentioned above are collectively referred to as terminals.

The base station 20 is an apparatus deployed in an access network to provide a wireless communication function for the terminal 10. The base station 20 includes various forms of satellite base stations, macro base stations, micro base stations, relay stations, access points, and the like. In systems employing different wireless access technologies, devices with functions of the base station are named differently, which may be referred to as, for example, gNodeB or gNB in a 5th-generation (5G) mobile communication new radio (NR) system. With the evolution of communication technologies, the name “base station” may change. For ease of description, in the embodiments of the present disclosure, the apparatuses configured to provide the wireless communication function for the terminal 10 as described above are collectively referred to as base stations.

In some embodiments, the network architecture further includes other network devices (not illustrated in FIG. 1), such as a central control node (CCN), an access and mobility management function (AMF) device, a session management function (SMF), or a user plane function (UPF).

The “5G NR system” in the embodiments of the present disclosure is also referred to as a 5G system or an NR system, but the meaning thereof may be understood by those skilled in the art. The technical solutions described in the embodiments of the present disclosure are applicable to the 5G NR system or applicable to a future evolved system of the 5G NR system.

Before solutions in various embodiments of the present disclosure are described, several terminological concepts involved in the present disclosure are first described.

### 1) SCell Activation/Deactivation

CA means enabling the NR system to support a larger bandwidth by jointly scheduling and using resources on a plurality of component carriers (CCs), thereby achieving a higher system peak rate. The plurality of CCs are further classified into primary component carriers (PCCs) and secondary component carriers (SCCs). Each CC corresponds to an independent cell.

There is only one PCC, and the corresponding cell is referred to as a primary cell (PCell). The PCell is responsible for RRC communication with a UE.

The SCC only provides additional wireless resources and the corresponding cell is referred to as a secondary cell (SCell). The UE is provided with a plurality of SCells. Each SCell corresponds to an index. When a configuration of the SCell is added to a network, an index value is indicated by sCellIndex IE. There is no RRC connection between the SCell and the UE. Add/Modify/Release of the configuration of the SCell needs to be performed by sending an RRC reconfiguration message (RRCReconfiguration) to the UE by the PCell.

Data of the UE does not need to be sent and received on a plurality of carriers in all slots. In order to achieve energy saving on the UE side, long-term evolution (LTE)/NR supports a SCell activation/deactivation mechanism. For a deactivated SCell, behaviors of the UE include:

not transmitting a sounding reference signal (SRS) on the SCell;

not reporting channel state information (CSI) of the SCell;

not sending an uplink shared channel (UL-SCH)/a physical uplink control channel (PUCCH)/a random access channel (RACH) on the SCell;

not monitoring a physical downlink control channel (PDCCH) sent on the SCell; and

not monitoring a PDCCH that schedules the SCell.

In the NR system, the SCell is activated/deactivated in the following three manners.

In the first manner, sCellState IE in the configuration of the SCell indicates activating/deactivating the SCell. When the SCell is added to the network, in the case that the configuration includes sCellState IE, the SCell is in an activated state; otherwise, the SCell is in a deactivated state.

In the handover scenario, a target cell performs an Add/Modify/Release operation based on a SCell list configured in a source cell. For a SCell where configuration parameters are added/modified, the state of the SCell is determined according to whether the configuration includes sCellState IE. For a SCell in the list that is not released, the state becomes the deactivated state.

In the second manner, the SCell is activated/deactivated based on a media access control (MAC) control element (CE). FIG. 2 is a schematic diagram of a secondary cell activation/deactivation message according to some embodiments of the present disclosure. As shown in FIG. 2, SCell Activation/Deactivation MAC CEs with lengths of 1 byte and 4 bytes are defined in a protocol, with Ci corresponding to the activated/deactivated state of the SCell with sCellIndex configured as i. In the case that Ci is set to 1, it indicates that the corresponding SCell is activated. In the case that Ci is set to 0, it indicates that the corresponding SCell is deactivated.

In the third manner, the SCell is deactivated based on a timer. The UE may maintain a sCellDeactivationTimer for each SCell according to the configuration. During the operation of the timer, the UE restarts the sCellDeactivationTimer each time the UE receives an uplink/downlink schedule from the network or performs uplink transmission. When the timer times out, the SCell enters the deactivated state.

### 2) Handover Process

Similar to an LTE system, the NR system supports a handover process of a UE in a connection state. When a user using a network service moves from one cell to another cell, or due to adjustment of a traffic load in a wireless transmission service, activation operation and maintenance, a device fault or other reasons, the system requires transfer of the user's communication link with an original cell to a new cell in order to ensure continuity of communication and quality of service, and a handover process is performed.

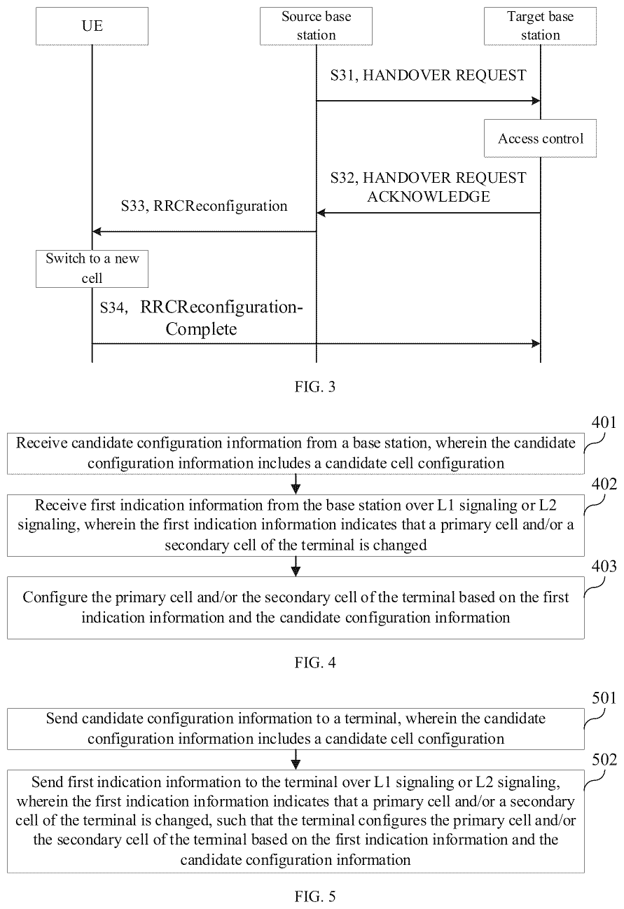

FIG. 3 is a schematic flowchart of cell handover across base stations according to some embodiments of the present disclosure. A general process is as follows.

In S31, a source base station triggers handover based on an L3 measurement result reported by a terminal, and sends a HANDOVER REQUEST to a target cell by an Xn interface.

In S32, a target base station receives the handover request from the source base station, provides an RRC configuration of the target cell, and feeds the RRC configuration back to the source base station as part of HANDOVER REQUEST ACKNOWLEDGE.

In S33, the source base station sends, to a UE, RRCReconfiguration to instruct the UE to initiate a handover process, as well as RRC configuration information used for accessing the target cell.

In S34, the UE accesses the target cell and sends RRCReconfigurationComplete to the target cell.

In some embodiments solution, the handover process is triggered by L3 signaling (such as RRC Reconfiguration). In order to further reduce the delay of L3 handover, a handover process that supports L1/L2 measurement/signaling is proposed in some embodiments of the present disclosure. Different from the L3 handover, in L1/L2 (L1 refers to a physical layer, and L2 refers to a MAC layer and/or a packet data convergence protocol (PDCP) layer) handover, part of cell configuration information is included in a handover command, the network provides configurations of candidate cells for the UE in advance according to RRC messages, and when there is a handover requirement, the UE is instructed to switch to one of the candidate cells over L1/L2 HO CMD.

L3 handover signaling includes changes to the configuration of the SCell, that is, Add/Modify/Release. For an added/modified SCell, the SCell state is indicated by ScellState. For other SCells in the list that have not been released, the SCells enter the deactivated state. After the handover is completed, the activation is indicated by the SCell Activation/Deactivation MAC CE. As can be seen, in the above handover process, the state of the SCell needs to be indicated according to RRC signaling+MAC CE (L2 signaling). When the solution described in the present disclosure supports the handover command of L1/L2 mobility, the handover signaling is delivered as a piece of L2 signaling to facilitate delivery of a SCell modification indication and/or state indication and the handover command to the UE over the same piece of L2 signaling. In other words, the solution described in the present disclosure solves the following problems:

how to indicate the update of the SCell over L1/L2 signaling, for example, Release/Add/Modify, and how to determine the state of the SCell during cell handover based on L1/L2 signaling.

FIG. 4 is a flowchart of a cell configuration method according to some embodiments of the present disclosure. The method is applicable to a terminal. The terminal is a terminal in the network architecture shown in FIG. 1. The method includes the following processes.

In process 401, candidate configuration information from a base station is received, wherein the candidate configuration information includes a candidate cell configuration.

In the embodiments of the present disclosure, the candidate configuration information includes several preset cell configurations. When subsequent cell handover occurs, the terminal may select, according to an indication from a network side, part of the cell configurations from the candidate configuration information to configure a primary cell and/or a secondary cell.

In process 402, the first indication information is received, wherein the first indication information is sent by the base station over L1 signaling or L2 signaling, and the first indication information indicates that a primary cell and/or a secondary cell of the terminal is changed.

The L1 signaling is physical layer signaling. The L2 signaling is MAC layer signaling or PDCP layer signaling.

In the embodiments of the present disclosure, the primary cell includes a special cell (SpCell), which represents a primary cell in a master cell group (MCG) or a secondary cell group (SCG).

In process 403, the primary cell and/or the secondary cell of the terminal are configured based on the first indication information and the candidate configuration information.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

FIG. 5 is a flowchart of a cell configuration method according to some embodiments of the present disclosure. The method is applicable to a base station. The base station is a base station in the network architecture shown in FIG. 1. The method includes the following processes.

In process 501, candidate configuration information is sent to a terminal, wherein the candidate configuration information includes a candidate cell configuration.

In process 502, first indication information is sent to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

FIG. 6 is a schematic diagram of a cell configuration process according to some embodiments of the present disclosure. As shown in FIG. 6, a terminal 601 is communicated with a base station 602 over CA.

In FIG. 6, the base station 602 first sends candidate configuration information to the terminal 601 (step S1), the candidate configuration information includes at least one candidate cell configuration. When subsequent cell handover occurs in the terminal 601, the base station 602 sends first indication information to the terminal 601 over L1/L2 signaling (step S2). The terminal 601 completes the configuration of the primary cell and/or the secondary cell upon the handover in combination with the first indication information and the candidate configuration information (step S3).

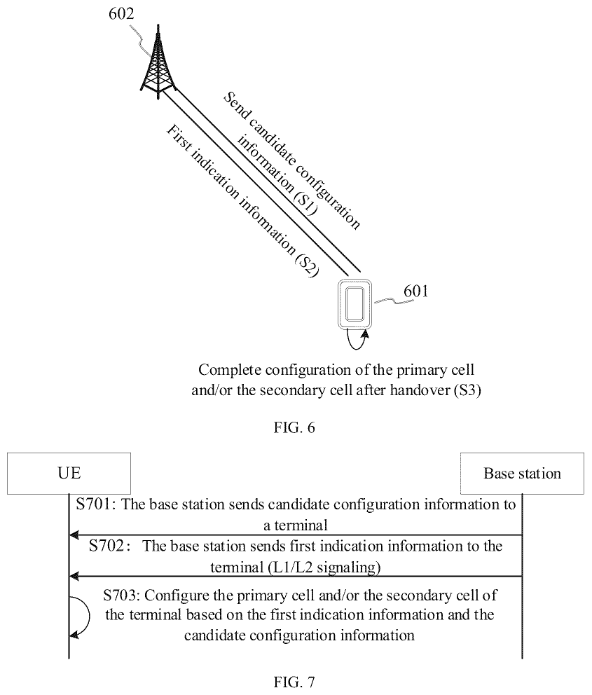

FIG. 7 is a flowchart of a cell configuration method according to some embodiments of the present disclosure. The method is performed interactively by a terminal and a base station. The terminal and the base station are the terminal and the base station in the network architecture shown in FIG. 1. As shown in FIG. 7, the method includes the following processes.

In process 701, the base station sends candidate configuration information to the terminal; and the terminal receives the candidate configuration information.

In the embodiments of the present disclosure, the candidate configuration information sent by the base station to the terminal is in the following manners.

### The Candidate Configuration Information Includes at Least One Candidate Cell Configuration.

Each of the at least one candidate cell configuration includes a candidate cell index, a measurement configuration, and candidate cell configuration information.

In other words, in some embodiments of the present disclosure, the candidate configuration information is set in units of candidate cell configurations. Each candidate cell configuration corresponds to a cell configuration manner.

In some embodiments, the candidate cell configuration information includes at least one of:

a cell identity (ID), a cell-radio network temporary identity (C-RNTI), a random access channel (RACH) resource, system information, a timing advance group (TAG) ID, an uplink bandwidth configuration, or a downlink bandwidth configuration.

In some embodiments of the present disclosure, the UE receives a first RRC message sent by the network. The first RRC message includes at least a first list (i.e., the candidate configuration information). The first list includes one or more candidate cell configurations. Each candidate cell is associated with at least:

a) a candidate cell index;

b) a measurement configuration; and

c) cell configuration information (i.e., the candidate cell configuration information). For example, the cell configuration information includes a cell ID, a C-RNTI, a RACH resource, system information, a TAG ID, an uplink/downlink bandwidth configuration, and the like.

In process 702, the base station sends the first indication information to the terminal over L1 signaling or L2 signaling; and the terminal receives the first indication information.

In some embodiments, the first indication information is at least one of:

first indication signaling indicating that the primary cell of the terminal is changed;

second indication signaling indicating that the secondary cell of the terminal is changed; or

third indication signaling indicating that the primary cell and the secondary cell of the terminal are both changed.

For example, the above three types of signaling are three different types of MAC CE signaling or downlink control information (DCI) signaling.

In some embodiments, the first indication information includes a first identification bit, wherein the first identification bit indicates one of the following situations:

the first indication information indicates that the primary cell of the terminal is changed;

the first indication information indicates that the secondary cell of the terminal is changed; and

the first indication information indicates that the primary cell and the secondary cell of the terminal are both changed.

In some other embodiments of the present disclosure, the base station on the network side alternatively uses the same type of signaling to indicate the configuration of the primary cell and/or the secondary cell. A cell type currently configured for the signaling is indicated according to the first identification bit in the signaling.

In some embodiments, the first indication information includes a first indication bit of a first secondary cell, wherein

the first indication bit indicates that the first secondary cell is changed.

In some embodiments, the first indication information includes a second indication bit of a second secondary cell, wherein

the second indication bit indicates that the second secondary cell is not changed.

In some embodiments, the first indication information further includes a third indication bit of the first secondary cell, wherein the third indication bit indicates a change type of the first secondary cell, wherein the change type is Add, Release, or Modify.

In some embodiments, the third indication bit indicates that the change type of the first secondary cell is Release when the third indication bit is 0.

In some embodiments, the third indication bit indicates that the change type of the first secondary cell is Add or Modify and the third indication bit indicates a first candidate cell index when the third indication bit is not 0; a candidate cell corresponding to the first candidate cell index is a target cell for performing an add or modify operation on the first secondary cell. In other words, the candidate cell corresponding to the first candidate cell index is a secondary cell to be added or a secondary cell to be modified.

In the embodiments of the present disclosure, the network side simultaneously indicates a change type of an added or modified first secondary cell and an added or modified target cell through one third indication bit. In other words, when the third indication bit includes the first candidate cell index, it indicates that a cell corresponding to the first candidate cell index is a secondary cell added or modified.

In some embodiments, the third indication bit indicates that the change type of the first secondary cell is Add or Modify when the third indication bit is 1; and the first indication information further includes a second candidate cell index;

wherein a candidate cell corresponding to the second candidate cell index is a target cell for performing an add or modify operation on the first secondary cell.

In the embodiments of the present disclosure, when the third indication bit is 1, it indicates that the first secondary cell is added or modified, and at the same time, the target cell added or modified is indicated according to another indication bit. In other words, when the third indication bit is 1, the first indication information further includes the corresponding first candidate cell index, and the cell indicated by the first candidate cell index is a secondary cell added or modified.

In some embodiments, the first indication information further includes fourth indication bits of modified or released secondary cells, wherein the fourth indication bits indicate cell indexes of the secondary cells.

In the embodiments of the present disclosure, for secondary cells that need to be modified or released in current secondary cells of the terminal, the network side carries cell indexes of the secondary cells modified or released in the first indication information to notify the terminal of which current secondary cells need to be modified or released.

In the embodiments of the present disclosure, the UE receives first indication information sent by the network. The first indication information is used for instructing the UE to replace a SpCell and/or a SCell. The first indication information is a MAC CE or DCI. Further, To distinguish different types of cell handover is described below.

For SpCell handover, SpCell+SCell handover, and SCell handover, the first indication information is three different pieces of signaling, for example, three different MAC CEs or DCIs.

The first indication information includes an identification bit. The identification bit is used for distinguishing different cell handover types.

When the first indication information is used for instructing the UE to replace the SCell, the first indication information includes at least:

a) SCell indexes that need to be modified/released (as shown in Table 1 below, as shown in the first row of bitmaps in Table 1, the bitmaps from high to low correspond to SCell indexes arranged in ascending/descending order, and setting to 1 indicates SCell indexes that need to be added/modified/released); and

b) Release/Add/Modify is further indicated for the SCell indexes that need to be added/modified/released indicated in a).

In a first implementation, as shown in Table 1, a bit position 0 configured to indicate Release/Add/Modify indicates Release, a bit position non-0 configured to indicate Release/Add/Modify indicates Add/Modify, and the non-0 setting indicates a candidate cell index. The number of bits occupied by the bits configured to indicate Release/Add/Modify is X bits.

TABLE 1

| | | | | | | | |
|---|---|---|---|---|---|---|---|
| R | 1 | 1 | 0 | 1 | 1 | 0 | 0 |
| R | 0 | Candidate | 0/— | 0 | Candidate | 0/— | 0/— |
| | (X bits) | Cellindex#1 | | (X bits) | Cell index#3 | | |
| | | (X bits) | | | (X bits) | | |

In a second implementation, as shown in Table 2, setting to 0 indicates Release, and setting to 1 indicates Add/Modify. In the case of setting to 1, the candidate cell index is further indicated. The number of bits occupied by the bits configured to indicate the candidate cell index is X bits.

TABLE 2

| | | | | | | | |
|---|---|---|---|---|---|---|---|
| R | 1 | 1 | 0 | 1 | 1 | 0 | 0 |
| R | 0 | 1 | 0/— | 0 | 1 | 0/— | 0/— |

| | |
|---|---|
| Candidate Cell index#1 (X bits) | Candidate Cell index#3 (X bits) |

In the solution, the values of X in the X bits in Table 1 and Table 2 above are not limited, where X is an integer value greater than or equal to 1.

For SCells that do not need to be released/modified, a Release/Add/Modify indication bit corresponds to 0, or the Release/Add/Modify indication bit is not included.

In addition, in the solution, the position of an reserved bit (R bit), whether the R bit is included, and the number of the R bit are not limited.

Taking Table 1 above as an example,

In Case1 (Release): the bitmap bit corresponding to the cell with SCell index=1 in the current SCell list is 1, and the change indication bit is 0, indicating that the SCell corresponding to SCell index=1 in the current SCell list is released.

In Case2 (Modify): the bitmap bit corresponding to the cell with SCell index=2 in the current SCell list is 1, and the change indication bit is non-0, indicating that the SCell corresponding to SCell index=2 in the current SCell list is released, the cell corresponding to the candidate cell index 1 is added as SCell, and the SCell index of the newly added SCell is 2.

In Case3 (Add): the bitmap bit corresponding to SCell index=5 is 1, but SCell index#5 is not in the current SCell list, indicating that the UE is instructed to add the cell corresponding to the candidate cell index 3 as a SCell, and the index of the newly added SCell is 5.

In process 703, the terminal configures the primary cell and/or the secondary cell of the terminal based on the first indication information and the candidate configuration information.

In the embodiments of the present disclosure, in the case of the first organization manner above, during the cell handover, the terminal configures the primary cell and/or the secondary cell of the terminal according to the content indicated by the first indication information in combination with the previously received candidate configuration information.

In some embodiments, the solution described in the embodiments of the present disclosure further includes:

for a secondary cell that is determined, based on the first indication information, as changed in a current secondary cell list of the terminal, setting a cell state of the changed secondary cell based on secondary cell state indication information contained in the candidate configuration information.

In the embodiments of the present disclosure, the cell state of the changed secondary cell during the cell handover is indicated by the candidate configuration information. Correspondingly, the terminal configures a cell state of the changed secondary cell upon the handover according to the candidate configuration information.

In some embodiments, the solution described in the embodiments of the present disclosure further includes:

for a secondary cell that is determined, based on the first indication information, as changed in a current secondary cell list of the terminal, setting a cell state of the changed secondary cell to an activated state or a deactivated state.

In the embodiments of the present disclosure, the cell state of the secondary cell changed during the cell handover is set by the terminal to a default activated state or deactivated state.

In some embodiments, the solution described in the embodiments of the present disclosure further includes:

for a secondary cell that is determined, based on the first indication information, as unchanged in a current secondary cell list of the terminal, in the case that a changed secondary cell belongs to the current secondary cell list of the terminal, setting a cell state of the unchanged secondary cell to a deactivated state, or keeping the cell state of the unchanged secondary cell unchanged.

In the embodiments of the present disclosure, the cell state of the secondary cell unchanged during the cell handover is set by the terminal to a default deactivated state, or the cell state before the cell handover is kept unchanged.

In some embodiments, the first indication information includes a fifth indication bit of a third secondary cell, wherein the third secondary cell is a newly added secondary cell, and the fifth indication bit indicates a cell state of the third secondary cell.

In some embodiments, the terminal sets the cell states of other secondary cells except the newly added secondary cell to a deactivated state, or keeps the cell states of the other secondary cells unchanged.

In the embodiments of the present disclosure, the cell states of the secondary cells newly added during the cell handover are indicated by the first indication information, and the terminal sets, according to the first indication information, the cell states of the secondary cells newly added upon the handover. The terminal sets cell states of secondary cells not newly added upon the handover to the default deactivated state or keeps the cell states of the secondary cells before the cell handover unchanged.

In some embodiments, the first indication information includes sixth indication bits of secondary cells, wherein the sixth indication bits indicate cell states of the secondary cells.

In the embodiments of the present disclosure, for the secondary cells after the handover, the network side also indicates the cell states of the secondary cells according to the first indication information, and during the handover, the terminal sets the cell states of the secondary cells after the handover according to the first indication information.

Based on the solution described in the embodiments of the present disclosure, the UE determines whether to update the configuration of the SCell or keep the current configuration of the SCell unchanged. For the two situations above, a SCell state determination method includes at least one of the following:

1) For a changed SCell, a state of the SCell is included in a candidate cell configuration, and SCellState IE is reused.

2) The changed SCell is in an activated state or a deactivated state by default.

3) The SCell whose list is unchanged enters the deactivated state or remains in the current state (for example, a target configuration and an original configuration are in the same set).

4) The state of the SCell is indicated by 1 bit in the first indication information.

Option 1: only a state of a newly added SCell is indicated, and other SCells enter the deactivated state or remain in the current state.

Option 2: states of all SCells in a SCell list are indicated.

In some embodiments, the first indication information includes seventh indication bits, wherein the seventh indication bits indicate field types of cell indexes of respective secondary cells.

In some embodiments, the terminal determines the field types of the cell indexes of the respective secondary cells in the first indication information based on the length of a current secondary cell list.

The first indication information further includes an indication bit, wherein the indication bit indicates that a bit of a SCell index is a segment field or a long field. Alternatively, the UE determines the length of a bitmap field according to the number of SCells in a current SCell list. For example, when there are 5 SCells in the current SCell list, a bitmap indicating the SCell index is 7 bits.

In some embodiments, the first indication information includes an eighth indication bit, wherein the eighth indication bit indicates whether the first indication information includes state information of the secondary cell, and/or the eighth indication bit indicates a type of state information of the secondary cell.

Further, the first indication information includes an indication bit, wherein the indication bit indicates whether Scell state information is included, and/or an indication type of state information.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

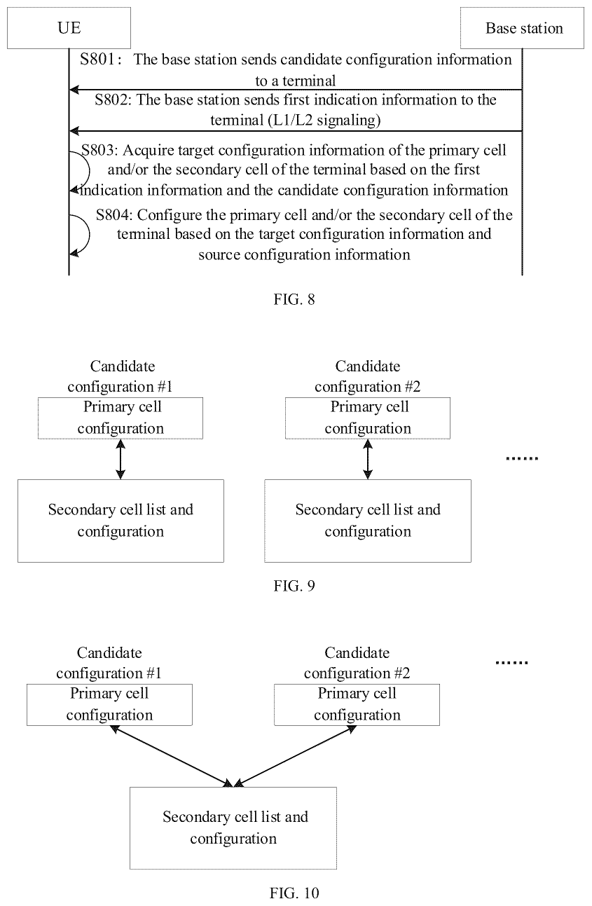

FIG. 8 is a flowchart of a cell configuration method according to some embodiments of the present disclosure. The method is performed interactively by a terminal and a base station. The terminal and the base station are the terminal and the base station in the network architecture shown in FIG. 1. As shown in FIG. 8, the method includes the following processes.

In process 801, the base station sends candidate configuration information to the terminal; and the terminal receives the candidate configuration information.

In the embodiments of the present disclosure, the candidate configuration information sent by the base station to the terminal is organized in the following manners.

### The Candidate Configuration Information Includes at Least One Configuration Set.

The configuration set includes a candidate configuration index, a primary cell configuration, and a secondary cell configuration associated with the primary cell configuration; or the configuration set includes a candidate configuration index, at least two primary cell configurations, and the same secondary cell configuration associated with the at least two primary cell configurations.

The secondary cell configuration includes a candidate secondary cell list and cell configuration information corresponding to the candidate secondary cell list.

In the embodiments of the present disclosure, the candidate configuration information is alternatively set in units of combinations of candidate cell configurations (i.e., the above configuration set). Each combination of candidate cell configurations corresponds to a combination of a primary cell configuration and a secondary cell configuration. The network side sets multiple possible combinations of the primary cell configuration and the secondary cell configuration in advance according to candidate configuration information, so as to instruct the terminal to select one of the combinations when the terminal subsequently performs cell handover.

In some embodiments, the candidate secondary cell list includes a first secondary cell list, wherein the first secondary cell list includes cell indexes of all secondary cells upon cell handover;

or the candidate secondary cell list includes a second secondary cell list, wherein the second secondary cell list includes cell indexes of secondary cells added, modified, and/or released based on a current secondary cell list of the terminal.

In other words, in the solution described in the embodiments of the present disclosure, in the case of the second organization manner above, the network side indicates cell configurations of secondary cells upon the cell handover to the terminal according to a candidate secondary cell list in the candidate configuration information; or the network side indicates, according to the candidate secondary cell list in the candidate configuration information, cell configurations of secondary cells added, modified, and/or released upon the cell handover compared with those before the handover.

In some embodiments of the present disclosure, in the case of the second organization manner above, the UE receives a first RRC message sent by the network. The first RRC message includes a second list. The second list includes one or more candidate configurations. Each candidate configuration includes:

a) a candidate cell index;

b) a measurement configuration;

c) SpCell cell configuration information; and

d) SCell cell configuration information; and the SCell configuration manner is:

i. a delta configuration based on a current SCell configuration list (i.e., a partial configuration); and

ii. a complete SCell list and a complete configuration.

A SpCell configuration and a SCell configuration are associated in at least one of the following manners.

In the first manner, refer to FIG. 9 which is a schematic diagram of association according to some embodiments of the present disclosure. Each SpCell is associated with a SCell configuration.

In the second manner, refer to FIG. 10 which is a schematic diagram of association according to some embodiments of the present disclosure. A plurality of SpCells are associated with a SCell configuration. For example, the candidate SpCells are referred to as a set 1. When the terminal replaces a SpCell in set 1, there is no need to replace the SCell configuration.

In process 802, the base station sends the first indication information to the terminal over L1 signaling or L2 signaling; and the terminal receives the first indication information.

In some embodiments, the first indication information includes a cell index of a target primary cell.

In process 803, the terminal acquires target configuration information of the primary cell and/or the secondary cell of the terminal based on the first indication information and the candidate configuration information.

In the embodiments of the present disclosure, the terminal acquires a configuration set corresponding to a target primary cell according to a cell index of the target primary cell; and acquires the configuration set corresponding to the target primary cell as the target configuration information.

The terminal queries the candidate configuration information for a candidate cell index of the primary cell contained in each configuration set, and when the candidate cell index of the primary cell in a certain configuration set matches the cell index of the target primary cell, determines the configuration set to be the configuration set corresponding to the target primary cell, and takes the configuration set as the target configuration information.

In process 804, the terminal configures the primary cell and/or the secondary cell of the terminal based on the target configuration information and source configuration information, wherein the source configuration information indicates the current configurations of the primary cell and/or the secondary cell of the terminal.

In some embodiments, the process in which the terminal configures the primary cell and/or the secondary cell of the terminal based on the target configuration information and source configuration information includes:

releasing a current secondary cell list of the terminal and cell configuration information corresponding to the current secondary cell list of the terminal and configuring the secondary cell based on the target configuration information in a case that the target configuration information and the source configuration information belong to different configuration sets, the target configuration information includes configuration information of the secondary cell, and the candidate secondary cell list includes the first secondary cell list.

In some embodiments, the process in which the terminal configures the primary cell and/or the secondary cell of the terminal based on the target configuration information and source configuration information includes:

updating the source configuration information based on the target configuration information to change the secondary cell in a case that the target configuration information and the source configuration information belong to different configuration sets, the target configuration information includes configuration information of the secondary cell, and the candidate secondary cell list includes the second secondary cell list.

In some embodiments, the process in which the terminal configures the primary cell and/or the secondary cell of the terminal based on the target configuration information and source configuration information includes:

retaining a current secondary cell list of the terminal and cell configuration information corresponding to the current secondary cell list of the terminal in a case that the target configuration information and the source configuration information belong to different configuration sets, the target configuration information does not include configuration information of the secondary cell, and the candidate secondary cell list includes the first secondary cell list.

In some embodiments, the process in which the terminal configures the primary cell and/or the secondary cell of the terminal based on the target configuration information and source configuration information includes:

releasing a current secondary cell list of the terminal and cell configuration information corresponding to the current secondary cell list of the terminal in a case that the target configuration information and the source configuration information belong to different configuration sets, the target configuration information does not include configuration information of the secondary cell, and the candidate secondary cell list includes the second secondary cell list.

In some embodiments, configuring the primary cell and/or the secondary cell of the terminal based on the target configuration information and source configuration information includes:

retaining a current secondary cell list of the terminal and cell configuration information corresponding to the current secondary cell list of the terminal in a case that the target configuration information and the source configuration information belong to the same configuration set.

In the embodiments of the present disclosure, the UE receives first indication information sent over a network, wherein the first indication information includes at least a first candidate configuration index; the UE determines a target configuration according to the first candidate configuration index; and the UE changes a SCell list based on the target configuration, including the following content.

a) The target configuration and a source configuration do not belong to the same set, and in the case that the target configuration includes a SCell configuration,

based on configuration i, the UE performs an add/release/modify operation on the current SCell list; and

based on configuration ii, the UE releases the current SCell list and configuration, and applies the SCell configuration in the target configuration.

b) The target configuration and the source configuration do not belong to the same set, and in the case that the target configuration does not include a SCell configuration,

based on configuration i, the UE does not change the current SCell list and configuration; and

based on configuration ii, the UE releases the current SCell list and configuration.

c) In the case that the target configuration and the source configuration are in the same set, the current SCell list and configuration are retained.

In some embodiments, the solution described in the embodiments of the present disclosure further includes:

for a secondary cell that is determined, based on the first indication information, as changed in a current secondary cell list of the terminal, setting a cell state of the changed secondary cell based on secondary cell state indication information contained in the candidate configuration information.

In some embodiments, the solution described in the embodiments of the present disclosure further includes:

for a secondary cell that is determined, based on the first indication information, as changed in a current secondary cell list of the terminal, setting a cell state of the changed secondary cell to an activated state or a deactivated state.

In some embodiments, the solution described in the embodiments of the present disclosure further includes:

for a secondary cell that is determined, based on the first indication information, as unchanged in a current secondary cell list of the terminal, when a changed secondary cell belongs to the current secondary cell list of the terminal, setting a cell state of the unchanged secondary cell to a deactivated state, or keeping the cell state of the unchanged secondary cell unchanged.

In some embodiments, the first indication information includes a fifth indication bit of a third secondary cell, wherein the third secondary cell is a newly added secondary cell, and the fifth indication bit indicates a cell state of the third secondary cell.

In some embodiments, the terminal sets cell states of other secondary cells except the newly added secondary cell to a deactivated state, or keeps the cell states of the other secondary cells unchanged.

In some embodiments, the first indication information includes sixth indication bits of respective secondary cells, wherein the sixth indication bits indicate cell states of the respective secondary cells.

In some embodiments, the first indication information includes seventh indication bits, wherein the seventh indication bits indicate field types of cell indexes of respective secondary cells.

In some embodiments, the terminal determines the field types of the cell indexes of the respective secondary cells in the first indication information based on the length of a current secondary cell list.

In some embodiments, the first indication information includes an eighth indication bit, wherein the eighth indication bit indicates whether the first indication information includes state information of the secondary cell, and/or the eighth indication bit indicates a type of the state information of the secondary cell.

The manner of setting the cell state in the embodiments of the present disclosure is similar to the manner of setting the cell state in the embodiments shown in FIG. 7, and details are not described herein again.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

The solution disclosed in the embodiments shown in FIG. 7 and the solution disclosed in the embodiments shown in FIG. 8 may be used separately or used in combination.

In other words, in the solution described in the above embodiments of the present disclosure, the UE is instructed to change at least one of the SpCell and the SCell over L1/L2 signaling, and/or a SCell state is indicated.

A method for instructing the UE to change at least one of the SpCell and the SCell includes the following solutions.

In the first solution, SCell change (Add/Release/Modify) information is contained in the candidate configuration, each candidate configuration includes SpCell+one or more SCell configurations, and the UE determines the target configuration from a plurality of candidate configurations by receiving L1/L2 signaling, thereby determining whether to change the SCell configuration.

In the second solution, SCell change information is contained in the L1/L2 signaling.

A method for indicating a SCell state includes the following solutions.

In the first solution, for a changed SCell, a state of the SCell is contained in the candidate cell configuration, and other unchanged SCells enter the deactivated state.

In the second solution, SCell state information is contained in the L1/L2 signaling indicating the cell handover.

In the third solution, the SCell state is the activated state/deactivated state/remains unchanged.

FIG. 11 is a block diagram of a cell configuration apparatus according to some embodiments of the present disclosure. The apparatus is applicable to a terminal. As shown in FIG. 11, the apparatus includes:

a receiving module 1101, configured to receive candidate configuration information from a base station, wherein the candidate configuration information includes a candidate cell configuration;

wherein the receiving module 1101 is further configured to receive first indication information from the base station over L1 signaling or L2 signaling, and the first indication information indicates that a primary cell and/or a secondary cell of the terminal is changed; and

a configuration module 1102, configured to configure the primary cell and/or the secondary cell of the terminal based on the first indication information and the candidate configuration information.

In some embodiments, the candidate configuration information includes at least one candidate cell configuration;

wherein each of the at least one candidate cell configuration includes: a candidate cell index, a measurement configuration, and candidate cell configuration information.

In some embodiments, the candidate cell configuration information includes at least one of:

a cell ID, a C-RNTI, a RACH resource, system information, a TAG ID, an uplink bandwidth configuration, or a downlink bandwidth configuration.

In some embodiments, the first indication information is at least one of:

first indication signaling indicating that the primary cell of the terminal is changed;

second indication signaling indicating that the secondary cell of the terminal is changed; or

third indication signaling configured to indicate that the primary cell and the secondary cell of the terminal are both changed.

In some embodiments, the first indication information includes a first identification bit, wherein the first identification bit indicates one of the following situations:

the first indication information indicates that the primary cell of the terminal is changed;

the first indication information indicates that the secondary cell of the terminal is changed; or

the first indication information indicates that the primary cell and the secondary cell of the terminal are both changed.

In some embodiments, the first indication information includes a first indication bit of a first secondary cell, wherein

the first indication bit indicates that the first secondary cell is changed.

In some embodiments, the first indication information includes a second indication bit of a second secondary cell, wherein

the second indication bit indicates that the second secondary cell is not changed.

In some embodiments, the first indication information further includes a third indication bit of the first secondary cell, wherein the third indication bit indicates a change type of the first secondary cell, wherein the change type is Add, Release, or Modify.

In some embodiments, the third indication bit indicates that the change type of the first secondary cell is Release in the case that the third indication bit is 0.

In some embodiments, the third indication bit indicates that the change type of the first secondary cell is Add or Modify and indicates a first candidate cell index in the case that the third indication bit is not 0; and

a candidate cell corresponding to the first candidate cell index is a target cell for performing an add or modify operation on the first secondary cell.

In some embodiments, the third indication bit indicates that the change type of the first secondary cell is Add or Modify in the case that the third indication bit is 1; and the first indication information further includes a second candidate cell index;

wherein a candidate cell corresponding to the second candidate cell index is a target cell for performing an add or modify operation on the first secondary cell.

In some embodiments, the first indication information further includes fourth indication bits of modified or released secondary cells, wherein the fourth indication bits indicate respective cell indexes of the secondary cells.

In some embodiments, the candidate configuration information includes at least one configuration set, wherein

each of the at least one configuration set includes a candidate configuration index, a primary cell configuration, and a secondary cell configuration associated with the primary cell configuration; or

each of the at least one configuration set includes a candidate configuration index, at least two primary cell configurations, and the same secondary cell configuration associated with the at least two primary cell configurations;

wherein the secondary cell configuration includes a candidate secondary cell list and cell configuration information corresponding to the candidate secondary cell list.

In some embodiments, the candidate secondary cell list includes a first secondary cell list, wherein the first secondary cell list includes cell indexes of all secondary cells upon cell handover; or

the candidate secondary cell list includes a second secondary cell list, wherein the second secondary cell list includes cell indexes of secondary cells added, modified, and/or released based on a current secondary cell list of the terminal.

In some embodiments, the configuration module 1102 is configured to:

acquire target configuration information of the primary cell and/or the secondary cell of the terminal based on the first indication information and the candidate configuration information; and

configure the primary cell and/or the secondary cell of the terminal based on the target configuration information and source configuration information, wherein the source configuration information indicates the current configurations of the primary cell and/or the secondary cell of the terminal.

In some embodiments, the first indication information includes a cell index of a target primary cell; and the configuration module 1102 is configured to:

acquire the configuration set corresponding to the target primary cell based on the cell index of the target primary cell; and

acquire the configuration set corresponding to the target primary cell as the target configuration information.

In some embodiments, the configuration module 1102 is configured to:

release a current secondary cell list of the terminal and cell configuration information corresponding to the current secondary cell list of the terminal and configure the secondary cell based on the target configuration information in the case that the target configuration information and the source configuration information belong to different configuration sets, the target configuration information includes configuration information of the secondary cell, and the candidate secondary cell list includes the first secondary cell list.

In some embodiments, the configuration module 1102 is configured to update the source configuration information based on the target configuration information to change the secondary cell in a case that the target configuration information and the source configuration information belong to different configuration sets, the target configuration information includes configuration information of the secondary cell, and the candidate secondary cell list includes the second secondary cell list.

In some embodiments, the configuration module 1102 is configured to retain the current secondary cell list of the terminal and cell configuration information corresponding to the current secondary cell list of the terminal in the case that the target configuration information and the source configuration information belong to different configuration sets, the target configuration information does not include configuration information of the secondary cell, and the candidate secondary cell list includes the first secondary cell list.

In some embodiments, the configuration module 1102 is configured to release the current secondary cell list of the terminal and cell configuration information corresponding to the current secondary cell list of the terminal in the case that the target configuration information and the source configuration information belong to different configuration sets, the target configuration information does not include configuration information of the secondary cell, and the candidate secondary cell list includes the second secondary cell list.

In some embodiments, the configuration module 1102 is configured to retain a current secondary cell list of the terminal and cell configuration information corresponding to the current secondary cell list of the terminal in the case that the target configuration information and the source configuration information belong to the same configuration set.

In some embodiments, the apparatus further includes:

a first state setting module configured to, for a secondary cell that is determined, based on the first indication information, as changed in a current secondary cell list of the terminal, set a cell state of the changed secondary cell based on secondary cell state indication information contained in the candidate configuration information.

In some embodiments, the apparatus further includes:

a second state setting module configured to, for a secondary cell that is determined, based on the first indication information, as changed in a current secondary cell list of the terminal, set a cell state of the changed secondary cell to an activated state or a deactivated state.

In some embodiments, the apparatus further includes:

a third state setting module configured to, for a secondary cell that is determined, based on the first indication information, as unchanged in a current secondary cell list of the terminal, set a cell state of the unchanged secondary cell to a deactivated state, and keep the cell state of the unchanged secondary cell unchanged.

In some embodiments, the first indication information includes a fifth indication bit of a third secondary cell, wherein the third secondary cell is a newly added secondary cell, and the fifth indication bit indicates a cell state of the third secondary cell.

In some embodiments, the apparatus further includes:

a fourth state setting module configured to set cell states of other secondary cells except the newly added secondary cell to a deactivated state, or keep the cell states of the other secondary cells unchanged.

In some embodiments, the first indication information includes sixth indication bits of respective secondary cells, wherein the sixth indication bits indicate cell states of the respective secondary cells.

In some embodiments, the first indication information includes seventh indication bits, wherein the seventh indication bits indicate field types of cell indexes of respective secondary cells.

In some embodiments, the apparatus further includes:

a field type determination module, configured to determine field types of cell indexes of respective secondary cells in the first indication information based on the length of a current secondary cell list of the terminal.

In some embodiments, the first indication information includes an eighth indication bit, wherein the eighth indication bit indicates whether the first indication information includes state information of the secondary cell, and/or the eighth indication bit indicates a type of the state information of the secondary cell.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

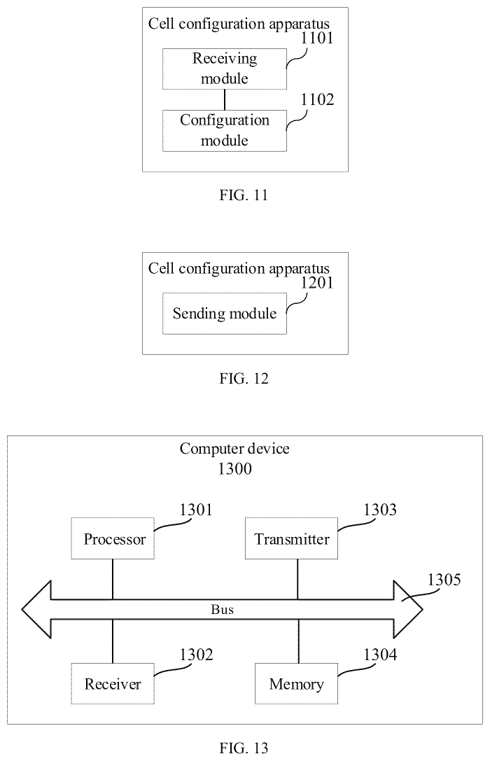

FIG. 12 is a block diagram of a cell configuration apparatus according to some embodiments of the present disclosure. The apparatus is applicable to a base station. As shown in FIG. 12, the apparatus includes:

a sending module 1201, configured to send candidate configuration information to a terminal, wherein the candidate configuration information includes a candidate cell configuration;

wherein the sending module 1201 is further configured to send first indication information to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

In some embodiments, the candidate configuration information includes at least one candidate cell configuration;

wherein each of the at least one candidate cell configuration includes: a candidate cell index, a measurement configuration, and candidate cell configuration information.

In some embodiments, the candidate cell configuration information includes at least one of:

a cell ID, a C-RNTI, a RACH resource, system information, a TAG ID, an uplink bandwidth configuration, or a downlink bandwidth configuration.

In some embodiments, the first indication information is at least one of:

first indication signaling indicating that the primary cell of the terminal is changed;

second indication signaling indicating that the secondary cell of the terminal is changed; or

third indication signaling indicating that the primary cell and the secondary cell of the terminal are both changed.

In some embodiments, the first indication information includes a first identification bit, wherein the first identification bit indicates one of the following situations:

the first indication information indicates that the primary cell of the terminal is changed;

the first indication information indicates that the secondary cell of the terminal is changed; or

the first indication information indicates that the primary cell and the secondary cell of the terminal are both changed.

In some embodiments, the first indication information includes a first indication bit of a first secondary cell, wherein

the first indication bit indicates that the first secondary cell is changed.

In some embodiments, the first indication information includes a second indication bit of a second secondary cell, wherein

the second indication bit indicates that the second secondary cell is not changed.

In some embodiments, the first indication information further includes a third indication bit of the first secondary cell, wherein the third indication bit indicates a change type of the first secondary cell, the change type being Add, Release, or Modify.

In some embodiments, the third indication bit indicates that the change type of the first secondary cell is Release in the case that the third indication bit is 0.

In some embodiments, the third indication bit indicates that the change type of the first secondary cell is Add or Modify and the third indication bit indicates a first candidate cell index in the case that the third indication bit is not 0; and

a candidate cell corresponding to the first candidate cell index is a target cell that performs an add or modify operation on the first secondary cell.

In some embodiments, the third indication bit indicates that the change type of the first secondary cell is Add or Modify in the case that the third indication bit is 1; and the first indication information further includes a second candidate cell index;

wherein a candidate cell corresponding to the second candidate cell index is a target cell for performing an add or modify operation on the first secondary cell.

In some embodiments, the first indication information further includes fourth indication bits of replaced or released secondary cells, wherein the fourth indication bits indicate cell indexes of the secondary cells.

In some embodiments, the candidate configuration information includes at least one candidate cell configuration, wherein

the configuration set includes a candidate configuration index, a primary cell configuration, and a secondary cell configuration associated with the primary cell configuration; or

the configuration set includes a candidate configuration index, at least two primary cell configurations, and the same secondary cell configuration associated with the at least two primary cell configurations;

wherein the secondary cell configuration includes a candidate secondary cell list and cell configuration information corresponding to the candidate secondary cell list.

In some embodiments, the candidate secondary cell list includes a first secondary cell list, wherein the first secondary cell list includes cell indexes of all secondary cells after cell handover; or

the candidate secondary cell list includes a second secondary cell list, wherein the second secondary cell list includes cell indexes of secondary cells added, modified, and/or released based on a current secondary cell list of the terminal.

In some embodiments, the first indication information includes a cell index of a target primary cell.

In some embodiments, the candidate configuration information further includes secondary cell state indication information, wherein the secondary cell state indication information indicates cell states of changed secondary cells.

In some embodiments, the first indication information includes a fifth indication bit of a third secondary cell, wherein the third secondary cell is a newly added secondary cell, and the fifth indication bit indicates a cell state of the third secondary cell.

In some embodiments, the first indication information includes sixth indication bits of secondary cells, wherein the sixth indication bits indicate cell states of the respective secondary cells.

In some embodiments, the first indication information includes seventh indication bits, wherein the seventh indication bits indicate field types of cell indexes of respective secondary cells.

In some embodiments, the first indication information includes an eighth indication bit, wherein the eighth indication bit indicates whether the first indication information includes state information of the secondary cell, and/or the eighth indication bit indicates a type of the state information of the secondary cell.

In summary, according to the solution described in the embodiments of the present disclosure, in the CA scenario, the terminal receives first indication information from the base station over L1 signaling or L2 signaling, and configures the primary cell and/or the secondary cell of the terminal in combination with the first indication information and pre-received candidate configuration information. That is, during the cell handover, the primary cell and/or the secondary cell is configured only by L1 signaling or L2 signaling interaction between the base station and the terminal, which saves signaling interactions between the terminal and the base station, thereby improving the communication efficiency of a system.

It should be noted that, when the apparatus according to the above embodiments implements the functions thereof, the division of the functional modules is merely exemplary. In practical application, the functions may be allocated to different function modules for implementation depending on actual requirements. That is, the device may be divided into different functional modules in terms of internal structure, to implement all or part of the functions described above.

For the apparatus in the foregoing embodiments, a specific manner in which each module performs operations has been described in detail in the embodiments related to the method, and details are not described herein.

FIG. 13 is a schematic structural diagram of a computer device 1300 according to some embodiments of the present disclosure. The computer device 1300 may include a processor 1301, a receiver 1302, a transmitter 1303, a memory 1304, and a bus 1305.

The processor 1301 includes one or more processing cores. The processor 1301 runs software programs and modules to run various functional applications and perform information processing.

The receiver 1302 and the transmitter 1303 may be implemented as one communications component. The communications component may be a communications chip. The communications chip may also be referred to as a transceiver.

The memory 1304 is connected to the processor 1301 by using the bus 1305.

The memory 1304 may be configured to store a computer program. The processor 1301 is configured to run the computer program to implement the processes performed by the terminal in the above method embodiments.

In addition, the memory 1304 may be implemented by any type of volatile or non-volatile storage device or a combination thereof. The volatile or non-volatile storage device includes, but is not limited to, a magnetic disk or an optical disc, an electrically erasable programmable read-only memory, an erasable programmable read-only memory, a static random access memory, a read-only memory, a magnetic memory, a flash memory, and a programmable read-only memory.

The above computer device may be implemented as the terminal or the base station in the above method embodiments.

In some exemplary embodiments, the computer device includes a processor, a memory, and a transceiver (the transceiver includes a receiver and a transmitter, wherein the receiver is configured to receive information, and the transmitter is configured to transmit information).

When the above computer device is implemented as the terminal in the above method embodiments,

the transceiver is configured to receive candidate configuration information from a base station, wherein the candidate configuration information includes a candidate cell configuration; and receive first indication information from the base station over L1 signaling or L2 signaling, and the first indication information indicates that a primary cell and/or a secondary cell of the terminal is changed; and

the processor is configured to configure the primary cell and/or the secondary cell of the terminal based on the first indication information and the candidate configuration information.

The processes performed by the transceiver and the processor are obtained with reference to all or some of the processes performed by the terminal in the embodiments shown in FIG. 4, FIG. 7, or FIG. 8 above, and details are not described herein again.

When the computer device is implemented as the base station in the above method embodiments, the transceiver is configured to send candidate configuration information to a terminal, wherein the candidate configuration information includes a candidate cell configuration; and send first indication information to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

The processes performed by the transceiver and the processor are obtained with reference to all or some of the processes performed by the base station in the embodiments shown in FIG. 5, FIG. 7, or FIG. 8 above, and details are not described herein again.

Some embodiments of the present disclosure further provide a computer-readable storage medium. The storage medium stores one or more computer programs. The one or more computer programs, when loaded and run by a processor, cause the processor to perform the processes performed by the terminal or the base station in the cell configuration method shown in FIG. 4, FIG. 5, FIG. 7, or FIG. 8.

The present disclosure further provides a computer program product or a computer program. The computer program product or the computer program includes one or more computer instructions stored in a computer-readable storage medium. The one or more instructions, when read from the computer-readable storage medium and executed by a processor of a computer device, cause the computer device to perform the processes performed by the terminal or the base station in the cell configuration method shown in FIG. 4, FIG. 5, FIG. 7, or FIG. 8.

The present disclosure further provides a computer program. The computer program includes one or more computer instructions stored in a computer-readable storage medium. The one or more instructions, when read from the computer-readable storage medium and executed by a processor of a computer device, cause the computer device to perform the processes performed by the terminal or the base station in the cell configuration method shown in FIG. 4, FIG. 5, FIG. 7, or FIG. 8.

The present disclosure further provides a chip. The chip is applicable to a terminal. The chip performs the processes performed by the terminal or the base station in the cell configuration method shown in FIG. 4, FIG. 5, FIG. 7, or FIG. 8.

Those skilled in the art should be aware that, in the foregoing one or more examples, functions described in the embodiments of the present disclosure may be implemented by hardware, software, firmware, or any combination thereof. When the functions are implemented by software, the functions may be stored in a computer-readable medium or transmitted as one or more program instructions or codes in the computer-readable medium. The computer-readable medium includes a computer storage medium and a communication medium. The communication medium includes any medium that enables a computer program to be transmitted from one place to another place. The storage medium may be any available medium accessible to a general-purpose or special-purpose computer.

The above are merely exemplary embodiments of the present disclosure, and are not intended to limit the present disclosure. Any modification, equivalent replacement, improvement, or the like made within the principles of the present disclosure shall fall within the protection scope of the present disclosure.

1. A cell configuration method, applicable to a terminal, the method comprising:
receiving candidate configuration information from a base station, wherein the candidate configuration information comprises a candidate cell configuration;
receiving first indication information from the base station over L1 signaling or L2 signaling, wherein the first indication information indicates that a primary cell and/or a secondary cell of the terminal is changed; and
configuring the primary cell and/or the secondary cell of the terminal based on the first indication information and the candidate configuration information.

2. The method according to claim 1, wherein the candidate configuration information comprises at least one candidate cell configuration;
wherein each of the at least one candidate cell configuration comprises: a candidate cell index, a measurement configuration, and candidate cell configuration information.

3. The method according to claim 2, wherein the candidate cell configuration information comprises at least one of:
a cell identity (ID), a cell-radio network temporary identity (C-RNTI), a random access channel (RACH) resource, system information, a timing advance group (TAG) ID, an uplink bandwidth configuration, or a downlink bandwidth configuration.

4. The method according to claim 2, wherein the first indication information is one of:
first indication signaling indicating that the primary cell of the terminal is changed;
second indication signaling indicating that the secondary cell of the terminal is changed; or
third indication signaling indicating that the primary cell and the secondary cell of the terminal are both changed.

5. The method according to claim 1, further comprising:
for a secondary cell that is determined, based on the first indication information, as changed in a current secondary cell list of the terminal, setting a cell state of the changed secondary cell based on secondary cell state indication information contained in the candidate configuration information.

6. The method according to claim 1, further comprising:
for a secondary cell that is determined, based on the first indication information, as changed in a current secondary cell list of the terminal, setting a cell state of the changed secondary cell to an activated state or a deactivated state.

7. The method according to claim 1, further comprising:
for a secondary cell that is determined, based on the first indication information, as unchanged in a current secondary cell list of the terminal, setting a cell state of the unchanged secondary cell to a deactivated state, or keeping the cell state of the unchanged secondary cell unchanged.

8. A terminal, comprising: a processor, a memory, and a transceiver; wherein
the transceiver is configured to receive candidate configuration information from a base station, wherein the candidate configuration information comprises a candidate cell configuration;
and receive first indication information from the base station over L1 signaling or L2 signaling, wherein the first indication information indicates that a primary cell and/or a secondary cell of the terminal is changed; and
the processor is configured to configure the primary cell and/or the secondary cell of the terminal based on the first indication information and the candidate configuration information.

9. The terminal according to claim 8, wherein the candidate configuration information comprises at least one candidate cell configuration;
wherein each of the at least one candidate cell configuration comprises: a candidate cell index, a measurement configuration, and candidate cell configuration information.

10. The terminal according to claim 9, wherein the candidate cell configuration information comprises at least one of:
a cell identity (ID), a cell-radio network temporary identity (C-RNTI), a random access channel (RACH) resource, system information, a timing advance group (TAG) ID, an uplink bandwidth configuration, or a downlink bandwidth configuration.

11. The terminal according to claim 9, wherein the first indication information is one of:
first indication signaling indicating that the primary cell of the terminal is changed;
second indication signaling indicating that the secondary cell of the terminal is changed; or
third indication signaling indicating that the primary cell and the secondary cell of the terminal are both changed.

12. The terminal according to claim 8, wherein the processor is configured to:
for a secondary cell that is determined, based on the first indication information, as changed in a current secondary cell list of the terminal, set a cell state of the changed secondary cell based on secondary cell state indication information contained in the candidate configuration information.

13. The terminal according to claim 8, wherein the processor is configured to:
for a secondary cell that is determined, based on the first indication information, as changed in a current secondary cell list of the terminal, set a cell state of the changed secondary cell to an activated state or a deactivated state.

14. The terminal according to claim 8, wherein the processor is configured to:
for a secondary cell that is determined, based on the first indication information, as unchanged in a current secondary cell list of the terminal, set a cell state of the unchanged secondary cell to a deactivated state, or keep the cell state of the unchanged secondary cell unchanged.

15. A base station, comprising: a processor, a memory, and a transceiver; wherein
the transceiver is configured to send candidate configuration information to a terminal, wherein the candidate configuration information comprises a candidate cell configuration; and send first indication information to the terminal over L1 signaling or L2 signaling, wherein the first indication information indicates that a primary cell and/or a secondary cell of the terminal is changed, such that the terminal configures the primary cell and/or the secondary cell of the terminal based on the first indication information and the candidate configuration information.

16. The base station according to claim 15, wherein the candidate configuration information comprises at least one candidate cell configuration;
wherein each of the at least one candidate cell configuration comprises: a candidate cell index, a measurement configuration, and candidate cell configuration information.

17. The base station according to claim 16, wherein the candidate cell configuration information comprises at least one of:
a cell identity (ID), a cell-radio network temporary identity (C-RNTI), a random access channel (RACH) resource, system information, a timing advance group (TAG) ID, an uplink bandwidth configuration, or a downlink bandwidth configuration.

18. The base station according to claim 16, wherein the first indication information is one of:
first indication signaling indicating that the primary cell of the terminal is changed;
second indication signaling indicating that the secondary cell of the terminal is changed; or
third indication signaling indicating that the primary cell and the secondary cell of the terminal are both changed.

19. The base station according to claim 16, wherein the first indication information comprises a first identification bit, wherein the first identification bit indicates one of following situations:
the first indication information indicates that the primary cell of the terminal is changed;
the first indication information indicates that the secondary cell of the terminal is changed; or
the first indication information indicates that the primary cell and the secondary cell of the terminal are both changed.

20. The base station according to claim 16, wherein the first indication information comprises a first indication bit of a first secondary cell, wherein
the first indication bit indicates that the first secondary cell is changed.
